(19) United States
(12) Patent Application Publication
(10) Pub. No.: US 2015/0097103 A1
(43) Pub. Date: Apr. 9, 2015

(54) FUEL GAUGE HOLDER

(71) Applicants: Richard Warren Sweeten, Pocasset, MA (US); James Farrell Holler, Marstons Mills, MA (US)

(72) Inventors: Richard Warren Sweeten, Pocasset, MA (US); James Farrell Holler, Marstons Mills, MA (US)

(21) Appl. No.: 14/506,549

(22) Filed: Oct. 3, 2014

Related U.S. Application Data
(60) Provisional application No. 61/886,120, filed on Oct. 3, 2013.

(51) Int. Cl. G01F 23/02; F16L 3/02; F16M 13/00

(52) U.S. Cl. CPC G01F 23/02; F16M 13/005; F16L 3/02
USPC 248/689

(57) ABSTRACT

Fuel testing gauges used in preflight checks of an aircraft are typically straw-shaped cylindrical elements which tend to accidentally slip through a fuel tank opening and become lost in the tank. A fuel gauge holder which resiliently engages the outer surface of the gauge and extends laterally from a central axis of the cylindrical gauge serves to prevent accidental loss of the gauge and simplifies handling by the pilot or other user of the fuel gauge.

### CROSS-REFERENCE

This application is a continuation-in-part of our provisional application Ser. No. 61/886,120, filed 3 Oct. 2013, the contents of which are hereby incorporated by reference (attorney docket 872-039-101).

### FIELD OF THE INVENTION

The present invention relates generally to devices for conducting an aviation preflight check and, more particularly, to a holder for attachment to a cylindrical clear tube, used to test for water in an aviation fuel tank.

### BACKGROUND

Pilots, for safety reasons, must conduct a preflight check of an aircraft, before powering up the aircraft or attempting taxi or take-off operations. Typically, this includes removing a fuel tank cap and testing for the presence of water contamination in the fuel by dipping a plastic fuel gauge or tube into the tank, pressing a finger over the upper tip of the tube, lifting the tube out of the tank, and visually inspecting the tube, to see if there is water anywhere in the tube.

If water is present, a drain at the bottom of the tank is opened, in order to remove the water and prevent it from interfering with operation of the aircraft engine. Sometimes, such tubes are slippery and there is a tendency to permit the tube to slip out of the pilot's grasp and fall into the tank, where it becomes difficult or inconvenient to retrieve.

### SUMMARY OF THE INVENTION

According, we have invented a fuel gauge holder adapted to fit onto the prior art cylindrical fuel gauge. This holder extends perpendicularly from the axis of the tube, for a sufficient distance to make it impossible to drop the holder and gauge into the fuel tank, and serves as a handle, making the gauge easier to manipulate.

### BRIEF FIGURE DESCRIPTION

A preferred embodiment of the invention is shown in the following figures.

FIG. 1 is a front view of the fuel gauge holder;

FIG. 2 is a rear view thereof;

FIG. 3 is a right side view, the left side view being the mirror image thereof;

FIG. 4 is a top view thereof;

FIG. 5 is a bottom view thereof; and

FIG. 6 is a top-front perspective view, the broken lines denoting an environment of use.

### DETAILED DESCRIPTION

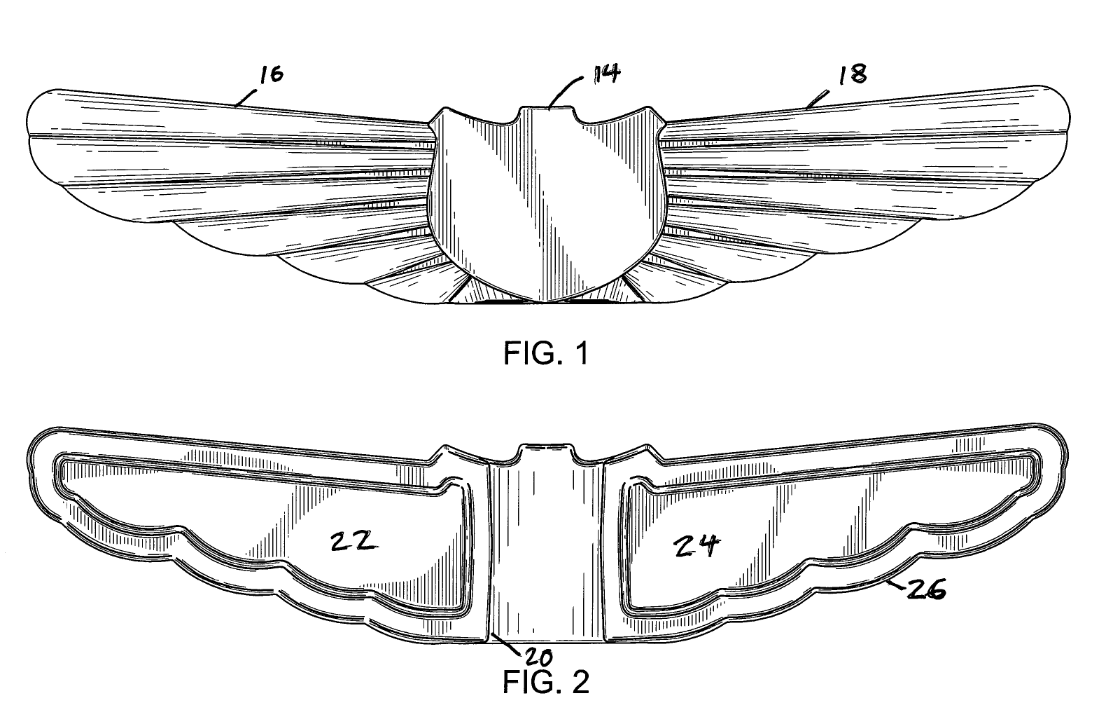

As shown FIG. 6, fuel gauge holder 10 is composed of a slightly resilient material and is adapted to fit onto a typical cylindrical fuel gauge tube 12, shown in dashed lines. As shown in FIG. 1, holder 10 preferably has a central portion 14, a left wing portion 16 and a right wing portion 18. In order for the holder to span a distance greater than a typical fuel tank opening, a suitable width of the holder is about 10 cm, i.e. 5 cm each direction from a center point. These three portions may be integrally formed, for example by casting, machining or injection-molding. The wing portions can be tapered toward their tips, so that, when attached to a fuel gauge extending into a tank, the holder-gauge combination will tend to be held in position by gravity, even if the pilot lets go momentarily.

As shown in FIG. 2, a rear surface of central portion 14 is curved to form a cylindrical bight 20, adapted to engage against and resiliently grip the outer cylindrical face of the fuel gauge tube 12. Molding of the holder can be facilitated by configuring it with a right-side hollow 22 and a left-side hollow 24, so that the wall thickness is small enough to permit quick cooling, upon removal from the mold, and the overall weight of the holder can be reduced.

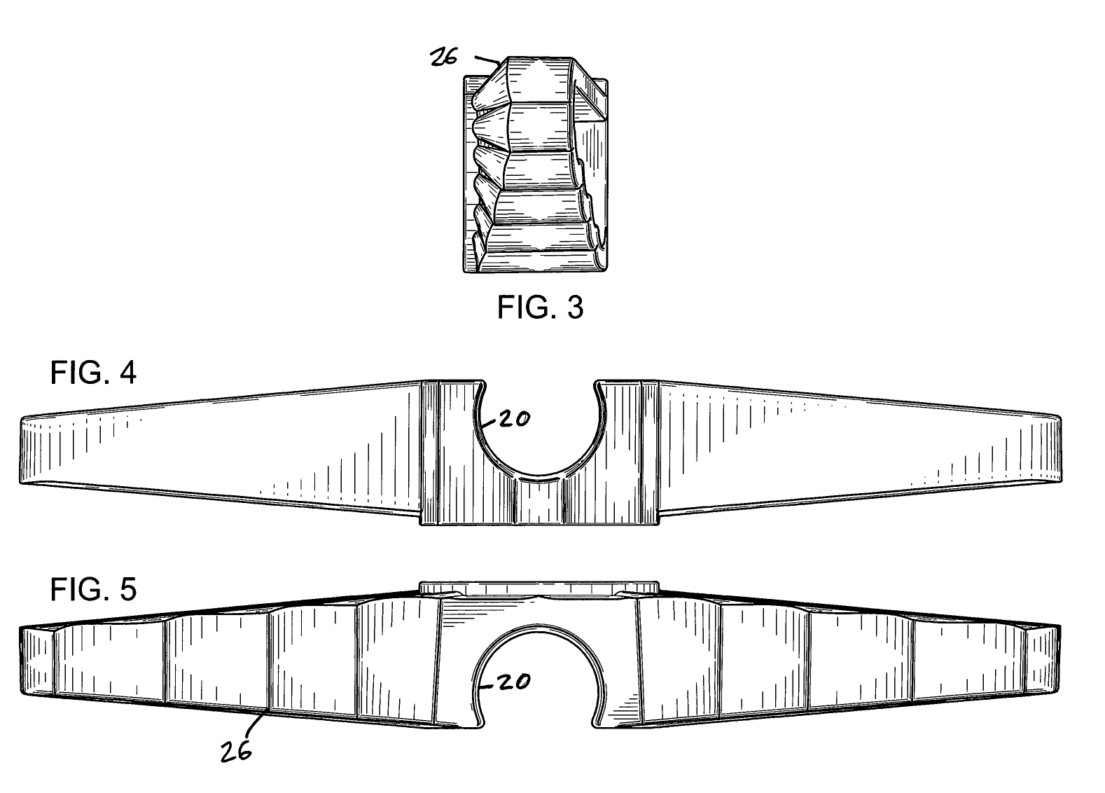

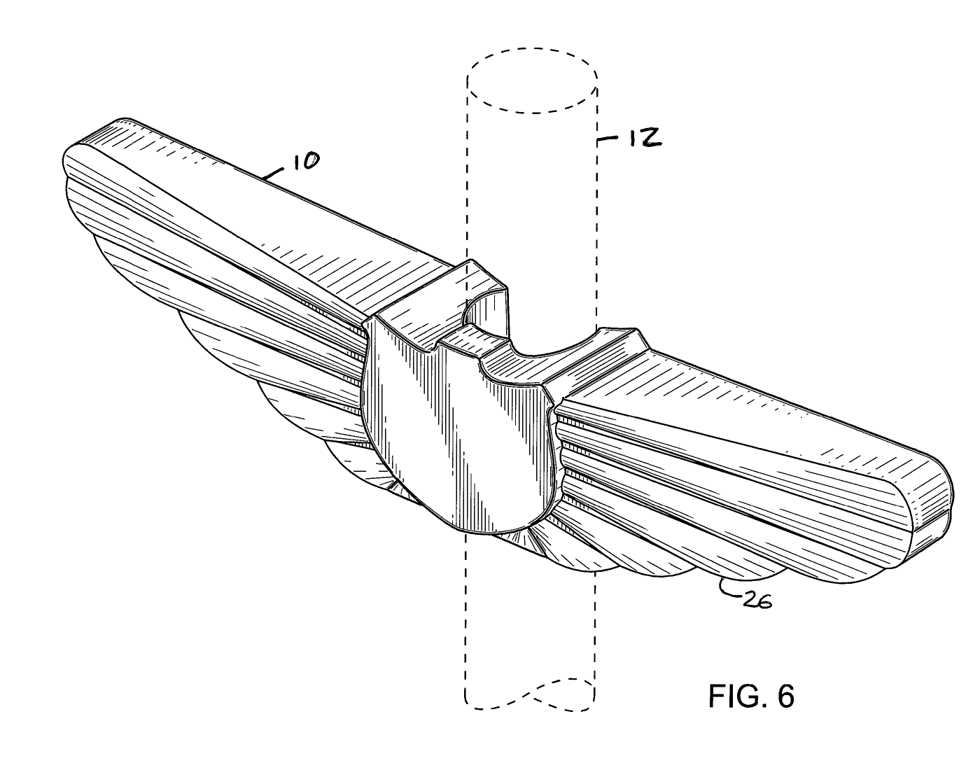

As shown in the right-side view of FIG. 3 and the bottom view of FIG. 5, the wing portions 16 and 18 have scallops or flutes 26, which present an attractive appearance and provide better frictional engagement with the hand of a user.

The material of the holder is preferably slightly resilient, so that the user can separate the holder from the cylindrical tube after use, to facilitate compact storage. Those having ordinary skill in the manufacturing art will appreciate that a number of different molding materials would have suitable properties. Two examples of suitable moldable plastics are ABS (acrylonitrile butadiene styrene) and HDPE (high density polyethylene). A holder composed of ABS has a yield strength of about 6300 psi, while a holder composed of HDPE has a yield strength of about 4000 psi.

Various changes and modifications are possible, within the scope of the inventive concept. Therefore, the invention is not limited to the embodiment shown and described, but rather is defined by the following claims.

What is claimed is:

1. A holder (10) adapted to secure to an elongated fuel gauge structure (12) having a central axis, comprising:
a central holder portion (14) formed with a bight (20) configured to frictionally engage an outer surface of said fuel gauge structure (12) and
a plurality of wing portions (14, 16) extending laterally with respect to said central axis of said fuel gauge structure (12) for a sufficient distance to prevent a gauge and holder, while engaged together, from sliding through a fuel tank opening of predetermined diameter.

2. The holder of claim 1, wherein said central portion and said wing portions are integrally formed.

3. The holder of claim 1, wherein said wing portions are a left wing (14) and a right wing (16), extending along a common axis perpendicular to said central axis of said fuel gauge structure (12).

4. The holder of claim 3, wherein said wing portions taper toward outer tips thereof.

5. The holder of claim 3, wherein said wing portions are formed with irregular outer surfaces to facilitate frictional engagement with a hand of a user.
